(19) United States
(12) Patent Application Publication
(10) Pub. No.: US 2015/0120256 A1
(43) Pub. Date: Apr. 30, 2015

(54) METHOD OF RECONSTRUCTING HAPLOTYPE OF DIPLOID AND SYSTEM THEREOF

(71) Applicants: Shujia Huang, Shenzhen (CN); Peng Sun, Shenzhen (CN); Honglong Wu, Shenzhen (CN); Jian Wang, Shenzhen (CN); Jun Wang, Shenzhen (CN); Huanming Yang, Shenzhen (CN)

(72) Inventors: Shujia Huang, Shenzhen (CN); Peng Sun, Shenzhen (CN); Honglong Wu, Shenzhen (CN); Jian Wang, Shenzhen (CN); Jun Wang, Shenzhen (CN); Huanming Yang, Shenzhen (CN)

(73) Assignee: BGI TECH SOLUTIONS CO., LTD., Shenzhen (CN)

(21) Appl. No.: 14/369,604

(22) PCT Filed: May 31, 2012
(86) PCT No.: PCT/CN2012/076324

§ 371 Date: Jun. 27, 2014

(30) Foreign Application Priority Data
Dec. 31, 2011 (CN) 201110456562.3

(51) Int. Cl. G06F 19/12; G06F 17/16; G06F 17/50

(52) U.S. Cl. CPC G06F 19/12; G06F 17/5009; G06F 17/16
USPC 703/2

(57) ABSTRACT

Provided is a method and system of reconstructing a haplotype of a diploid. The method can include constructing a matrix of sequence fragments consisting of ternary character based on sequence fragments comprising at least one common site, wherein in the matrix of sequence fragments, two allelic bases of an SNP site in chromosome fragments are labeled with A and B respectively; initializing two fragment sets of based on the matrix of sequence fragments; determining an objective function and an initial reference temperature; performing a process of simulated annealing based on the objective function and the initial reference temperature, and outputting final sets until a convergence criteria is achieved; inferring a haplotype based on the final sets by means of minimum error correction.

### TECHNICAL FIELD

Embodiments of the present disclosure generally relate to a field of bioinformatics, more particularly, to a method of reconstructing a haplotype of a diploid and a system thereof.

### BACKGROUND

Difference of a single base at a same site in a genome among different individual DNA sequences is called as single nucleotide polymorphism (SNP). SNP is the most common genetic variation in a genome. It is estimated that approximately ten million of SNP sites present in human population, in which about 90% is shared in human population. Haplotype refers to a group of associated SNP alleles in one chromosome or a certain region. Haplotype is one major way to describe genetic difference of human genome, which is also extensively used in genome associated study, population genetics, and etc.

In 2002, some states such as US, UK, China and etc launched an international Haplotype Map (HapMap) project, directing to establish a public and genome wide database of common human sequence variation, to provide valuable information for genetic research of clinical phenotype. As gradual completion of HapMap stage I, stage II and stage III, scientists from various states has already successfully typed multimillions of SNP sites deriving from more than one thousand samples of 11 different populations such as African, Asian, European, and etc, and constructed haplotype maps of different populations. Besides, with deepening understandings with structure of human genome (comprising SNP in genome, homozygous\heterozygous deletion, chromosome inversion, copy number variation, etc), understandings with a haplotype structure and a distribution within the population also becomes more and more obvious. Meanwhile, with increasingly mature and extensively application of the Next-Generation sequencing technology, a large amount of fragment information of chromosome in human genome is obtained. By then, it may no longer reconstruct a haplotype of a single individual based on SNP genotype information of population entirely depending on statistical methods, while it may directly complete reconstruction by connecting chromosome fragments of the single individual comprising heterozygous SNP sites. It has been proved by many papers that, the constructed haplotype based on fragments connecting way has higher accuracy and integrity.

To construct a haplotype based on chromosome fragment information, many researches provide different objective functions for obtaining most optimal result of haplotype reconstruction, which comprises: minimum fragment removal (MFR), minimum error correction (MEC), minimum SNP removal (MSR), etc. Recently, there are many methods of reconstructing a haplotype by taking MEC as an objective function (i.e., making difference between the reconstructed haplotype and known chromosome fragment being minimum). Such methods comprise:

1. Greedy heuristic algorithm proposed by Levy et al.: the central constructs thereof is to make known chromosome fragments having a minimum difference with the reconstructed haplotype based on greedy heuristic algorithm. When sequencing error does not present in heterozygous SNP site, this method may rapidly obtain a most optimal haplotype. When sequencing error presents in heterozygous SNP site, this method is time-consuming with a relative low accurate result.

2. HapCUT: the central constructs thereof is to calculate weight value among SNP sites (based on MEC) by initializing a haplotype and establishing a matrix of chromosome fragments. SNP site are divided into two classes by constructing a bipartite graph according to the weight value, and subjected to multiple iterations, and then get optimization, and finally the haplotype is reconstructed in accordance to the most optimal SNP classified result. When data comprise relative more chromosome fragments and heterozygous SNP sites, this method is time-consuming and the obtained result usually is just a local optima but not a global optima.

3. ReFHap: this method is similar with HapCUT, which are both to construct a bipartite graph, other than to classify SNP sites therein, but to classify all chromosome fragments into two categories in accordance with similarity level, after subjected to multiple iterations, the obtained two category sets of chromosome fragments having the highest level of difference are taken as a final results, on which are based to reconstruct the haplotype. Although this method is shorter time-consuming with a high accuracy, it also cannot avoid the disadvantage that the obtained results easily get into local optima.

In summary, it is an urgent problem to develop a novel method of reconstructing a haplotype with high accuracy and short time-consuming characteristic, which may obtain global optima haplotype.

### SUMMARY

One technical solution to be solved by one aspect of the present disclosure is to provide an accurate and rapid method of reconstructing a haplotype of a diploid and a system thereof.

According to one aspect of the present disclosure, there is provided a method of reconstructing a haplotype of a diploid. According to embodiments of the present disclosure, the method may comprise following steps:

constructing a matrix M of m×n sequence fragments consisting of ternary character {A, B, C} based on sequence fragments comprising at least one common site, wherein in the matrix M of m×n sequence fragments, two allelic bases of an SNP site in chromosome fragments are labeled with A and B respectively, m is the number of rows of the matrix M, and m represents the number of the chromosome fragments, n is the number of columns of the matrix M, and n represents the number of heterozygous SNP sites;

initializing two fragment sets S and T based on the matrix M of m×n sequence fragments, wherein S∪T=M and S∩T=φ, φ represents a null set;

determining an objective function ζ(S,T)=ΣΣε(M,i,j) and an initial reference temperature T₀, wherein i∈S, j∈T, ε(M,i,j) represents a difference value between the total number of fragments having a same base type of fragments i and those of fragments j and the total number of fragments having different base type of the fragments i and those of fragments j;

performing a process of simulated annealing based on the objective function and the initial reference temperature T₀, and outputting final sets S and T until a convergence criteria is achieved;

inferring a haplotype h based on the final sets S and T by means of minimum error correction.

Optionally, the initial reference temperature T₀ is T₀=−|Δmax|/ln(pr), wherein

|Δmax|=ζₘₐₓ−ζₘᵢₙ,

pᵣ is an initial acceptance probability,

ζₘₐₓ/ζₘᵢₙ represents the maximum/minimum value in all ζ values of every group of S and T, which is calculated based on K groups of sets consisting of the two sets of S and T which are randomly generated by the matrix M,

K is a natural number being 2 or more.

Optionally, the step of performing a process of simulated annealing based on the objective function and the initial reference temperature T₀ comprises:

determining a range of an optimal solution by a sub-process of annealing under high temperature, wherein a function of the annealing under high temperature is T=T₀exp(−α(j−1)^{1/2});

performing a sub-process of annealing under low temperature when the sub-process of annealing under high temperature is stable, wherein a function of the annealing under low temperature is T=T₀exp(−α(j−k0/β)^{1/2});

wherein T₀ is the initial reference temperature, j represents times of annealing, k₀ represents times of the annealing under high temperature, α=0.98, β=1.2.

Optionally, the method of reconstructing the haplotype of the diploid may further comprise a step of:

determining whether or not stop iterating and start annealing by Metropolis sampling stability criteria.

Optionally, the convergence criteria for the process of simulated annealing is that:

whether whole algorithm has reached a final convergence is determined when ζ value of the objective function remains constant after continuously annealing for predetermined times.

Optionally, the ternary character {A, B, C} is {0, 1, -}.

Optionally, the step of inferring the haplotype h based on the final sets S and T by means of minimum error correction comprises:

for each column j, j∈[1, n], m_{j,0} represents the number of 0 in the column, m_{m,1} represents the number of 1 in the column, hⱼ represents the inferred base type of the column;

hⱼ=0, if m_{j,0}>m_{j,1};

hⱼ=1, if m_{j,1}>m_{j,0};

hⱼ=-, if not belonging to the above two cases.

Optionally, the method of reconstructing the haplotype of the diploid may further comprise a step of:

subjecting the SNP site in chromosome fragments to filtering, to remove a homozygous SNP site and an SNP site, wherein the SNP site comprising two or more allelic bases.

According to another aspect of the present disclosure, there is provided a system for reconstructing a haplotype of a diploid. According to embodiments of the present disclosure, the system may comprise:

a matrix constructing module, configured to construct a matrix M of m×n sequence fragments consisting of ternary character {A, B, C} based on all sequence fragments comprising at least one common site, wherein in the matrix M of m×n sequence fragments, two allelic bases of an SNP site in chromosome fragments are labeled with A and B respectively, m is the number of rows of the matrix M, and m represents the number of the chromosome fragments, n is the number of columns of the matrix M, and n represents the number of heterozygous SNP sites;

an initial condition determining module, configured to initialize two fragment sets S and T based on the matrix M of m×n sequence fragments, wherein S∪T=M and S∩T=φ, φ represents a null set; and to determine a objective function ζ(S,T)=ΣΣε(M,i,j) and an initial reference temperature T₀, wherein i∈S, j∈T, ε(M,i,j) represents a difference value between the total number of fragments having a same base type of fragments i and those of fragments j and the total number of fragments having different base type of the fragments i and those of fragments j;

a simulated annealing iteration module, configured to perform a process of simulated annealing based on the objective function and the initial reference temperature T₀, and to output final sets S and T until a convergence criteria is achieved;

a haplotype determining module, configured to infer a haplotype h based on the final sets S and T by means of minimum error correction.

Optionally, the initial reference temperature T₀ is T₀=−|Δmax|/ln(pr), wherein

|Δmax|=ζₘₐₓ−ζₘᵢₙ,

pᵣ is an initial acceptance probability,

ζₘₐₓ/ζₘᵢₙ represents the maximum/minimum value in all ζ values of every group of S and T, which is calculated based on K groups of sets consisting of the two sets of S and T which are randomly generated by the matrix M,

K is a natural number being 2 or more.

Optionally, the simulated annealing iteration module may comprise:

a first executing unit, configured to perform a sub-process of annealing under high temperature and determine a range of a optimization optimal solution thereby, wherein a function of the annealing under high temperature is T=T₀exp(−α(j−1)^{1/2});

a judging unit, configured to determine whether or not the sub-process of annealing under high temperature is stable, and to convert to a sub-process of annealing under low temperature when the sub-process of annealing under high temperature is stable;

a second executing unit, configured to perform the sub-process of annealing under low temperature, wherein a function of the annealing under low temperature is T=T₀exp(−α(j−k0/β)^{1/2});

wherein T₀ is the initial reference temperature, j represents times of annealing, k₀ represents times of the annealing under high temperature, α=0.98, β=1.2.

Optionally, the simulated annealing iteration module determines whether or not stop iterating and start annealing by Metropolis sampling stability criteria.

Optionally, the convergence criteria for the process of simulated annealing used by the simulated annealing iteration module is that:

whether whole algorithm has reached a final convergence is determined when value of the objective function remains constant after continuously annealing for predetermined times.

Optionally, in the haplotype determining module,

for each column j, jε[1, n], m_{j,0} represents the number of 0 in the column, m_{j,1} represents the number of 1 in the column, hⱼ represents the inferred base type of the column;

hⱼ=0, if m_{j,0}>m_{j,1};

hⱼ=1, if m_{j,1}>m_{j,0};

hⱼ=-, if not belonging to the above two cases.

Optionally, the system for reconstructing the haplotype of the diploid may further comprise:

an SNP site filtering module, configured to subject the SNP site in chromosome fragments to filtering, to remove a homozygous SNP site and an SNP site, wherein the SNP site comprising two or more allelic bases.

The method of reconstructing the haplotype of the diploid and the system thereof comprising performing the process of simulated annealing based on the objective function and the initial reference temperature, outputting the final sets S and T when convergence, inferring the haplotype by means of minimum error correction, to obtain a haplotype of global optimal solution with high accuracy and fast speed.

### BRIEF DESCRIPTION OF THE DRAWINGS

FIG. 1 is a flow chart showing a method of reconstructing a haplotype of a diploid according to an embodiment of the present disclosure;

FIG. 2 is a flow chart showing a method of reconstructing a haplotype of a diploid according to another embodiment of the present disclosure;

FIG. 3 is a flow chart showing a method of reconstructing a haplotype of a diploid according to a still another embodiment of the present disclosure;

FIG. 4 is a graph showing an effect of different α value of an annealing function on a cooling rate during a sub-process of annealing under high temperature;

FIG. 5 is a graph showing an effect of different β value of an annealing function on a cooling rate during a sub-process of annealing under low temperature;

FIG. 6 is a graph showing an effect of an overlapping degree extent between two chromosome fragments on the accuracy of haplotype reconstruction;

FIG. 7 is a graph showing a relationship between an error rate of reconstructed haplotype and an error rate of SNP introduced by sequencing at different depth;

FIG. 8 is a structural chart showing a system for reconstructing a haplotype of a diploid according to an embodiment of the present disclosure;

FIG. 9 is a structural chart showing a system for reconstructing a haplotype of a diploid according to another embodiment of the present disclosure;

FIG. 10 shows an example of bipartite graph.

### DETAILED DESCRIPTION

More comprehensive description will be made in detail to embodiments of the present disclosure referring to figures. The embodiments described herein are explanatory, illustrative, and used to generally understand the present disclosure. The embodiments shall not be construed to limit the present disclosure.

The basic idea of the present disclosure lies in a method of constructing a bipartite graph with sequence fragments obtained by sequencing in accordance with a difference level based on simulated annealing algorithm, to realize haplotype reconstruction, directing at rapidly and accurately completing haplotype reconstruction in a genome (such as human) under the background of massive sequencing data.

I. Brief Description of Simulated Annealing Algorithm

The simulated annealing algorithm derives from a principle of solid annealing in physical system, which comprises: heating a solid up to a sufficiently high temperature, then chilling the heated solid slowly. During heating, internal particles of the solid become a disordered state with the rising temperature, which results in an enhanced intrinsic energy. While by slowly chilling, the disordered internal particles gradually get back to an ordered state. Equilibrium states achieve at every temperature, a ground state achieves at normal temperature finally, at which the intrinsic energy decreases to the minimum. According to Metropolis criteria, a probability of particles becoming balanced at a temperature of T is e−ΔE/(kT), in which E is an intrinsic energy at the temperature of T, ΔE is a variation of the intrinsic energy, k is a Boltzmann constant (with a value being as K=1.3806505×10⁻²³ J/K). Such algorithm is a random search algorithm for solving large-scale optimization problem, which is based on a similarity between a process of problem-solving optimization and a process of physical system annealing. A objective function of optimization is equivalent to metal intrinsic energy; a state-space of variation combination of the optimization problem is equivalent to a state-space of metal intrinsic energy; the process of problem-solving is to find a combinatorial state, which makes the objective function having a minimum value (or a maximum value). The simulated annealing is realized using the Metropolis criteria and appropriately controlling a process of temperature decrease, by which achieve the target of solving the global optima problem within polynomial time.

Problem of reconstruction a haplotype is a problem of solving combinatorial optimization. The problem of combinatorial optimization is simulated using solid annealing, in which intrinsic energy E is simulated as a value f of an objective function, a temperature of T evolved to a controlling parameter of t, i.e., a simulated annealing algorithm of solving the problem of combinatorial optimization is obtained: starting with an initial solution i and an initial value t of the controlling parameter, subjecting current solution to multiple iterations of “generating new solution→calculating a difference value of the objective function→accepting or discarding” with gradually attenuating the value of t, by which the obtained solution when the algorithm terminates is the obtained approximate optimal solution. The above is a heuristic random search process based on a solving method of Monte Carlo iteration.

II. Basic Conception of Bipartite Graph

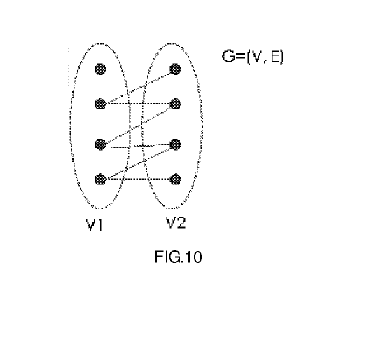

The bipartite graph also known as a bigraph, is a special module in graph theory. Assuming that G=(V, E) is an undirected graph, if a vertex of V thereof can be partite into two disjoint subsets (V1, V2), vertex i related to a border i in the graph belongs to one vertex set (iεV1), while vertex j related to a border j in the graph belongs to the other vertex set (jεV2), then the graph of G is a bipartite graph shown as FIG. 10.

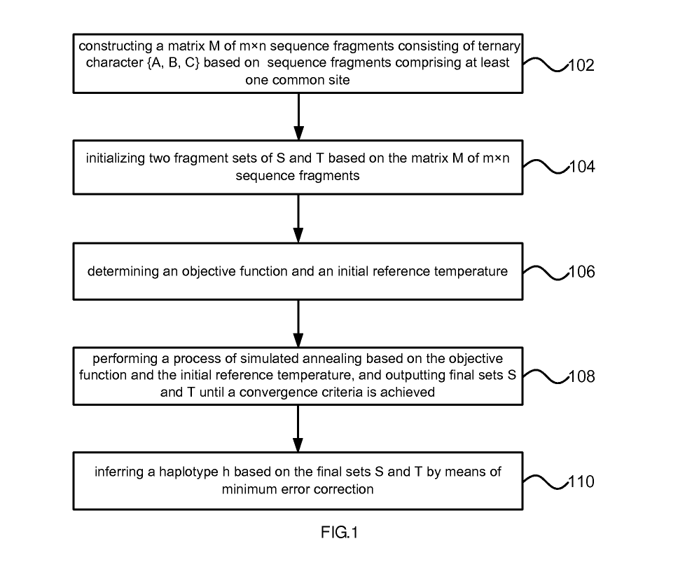

FIG. 1 shows is a flow chart showing a method of reconstructing a haplotype of a diploid according to an embodiment of the present disclosure.

As shown in FIG. 1, step 102 comprises: constructing a matrix M of m×n sequence fragments consisting of ternary character {A, B, C} based on sequence fragments comprising at least one common site, in which in the matrix M of m×n sequence fragments, two allelic bases of an SNP site in chromosome fragments are labeled with A and B respectively, m is the number of rows of the matrix M, and m represents the number of the chromosome fragments, n is the number of columns of the matrix M, and n represents the number of heterozygous SNP sites. For example, the two allelic bases of an SNP site in chromosome fragments are switched to be labeled with 0 and 1 in accordance with an order sequence in ASCII code, i.e., 0 represents a relative smaller value in ASCII code, while 1 represents a relative larger value in ASCII code; and the sequence fragments comprising at least one common site are gathered together to construct a two-dimensional matrix of m×n sequence fragments, recording as M, in which m is the number of rows of the matrix M, and m represents the number of the chromosome fragments, n is the number of columns of the matrix M, and n represents the number of heterozygous SNP sites; if a certain chromosome fragment does not comprise a certain SNP site, then a corresponding site thereof in the matrix is recorded as “-”. Then a matrix of m×n sequence fragments consisting of ternary character {1, 0, -} has been constructed by the above-mentioned.

Step 104 comprises: initializing two fragment sets of S and T based on the matrix M of m×n sequence fragments, wherein S∪T=M and S∩T=φ, φ represents a null set. The fragment sets of S and T may be selected randomly.

Step 106 comprises: determining an objective function ζ(S,T)=ΣΣε(M,i,j) and an initial reference temperature T₀, wherein i∈S, j∈T, ε(M,i,j) represents a difference value between the total number of fragments having a same base type of fragments i and those of fragments j and the total number of fragments having different base type of the fragments i and those of the fragments j. Assuming that all sequence fragments in the fragment set S derive from one same haplotype, while all sequence fragments in the fragment set T completely derive from another same haplotype, then the different value between the two fragment sets of S and T is the maximal value. When ζ(S,T) achieves a maximal value, then all fragments in S and T may be regarded as respectively deriving from two different haplotypes. The selection of the initial reference temperature will be introduced by an example below.

Step 108 comprises: performing a process of simulated annealing based on the objective function and the initial reference temperature T₀, and outputting final sets S and T until a convergence criteria is achieved. The convergence criteria may be selected and adjusted as required by those skilled in the art.

Step 110 comprises: inferring a haplotype h based on the final sets S and T by means of minimum error correction (MEC). For example, the step of inferring the haplotype h by a model of minimum error correction comprises: for each column j (j∈[1, n]), in which m_{j,0} represents the number of 0 in the column, m_{j,1} represents the number of 1 in the column, hⱼ represents the inferred base type of the column. If m_{j,0}>m_{j,1}, then hⱼ=0; if m_{j,1}>m_{j,0}, then hⱼ=1; and hⱼ=- represents being uncertain in the case of not belonging to the above two cases.

In the above embodiments, the matrix is constructed with m×n sequence fragments, which is then subjected to the process of simulated annealing based on the objective function and the initial reference temperature; then the final sets S and T are output when convergence, with which the haplotype may be inferred by the model of minimum error correction, so as to obtain a global optimal haplotype with a high accuracy. Since the same and different base types are both considered among fragments, the objective function can also avoid disadvantage resulted from insufficient information quantity, such as only considering a value of site of a different base type. Such disadvantage may be illustrated by following examples:

fragment f1: 1011111011111

fragment f2: 101100c1---------

fragment f3: 1011010111111
. . .

In the case of only considering site of different base type, then a difference value between f₂ and f₃ is regarded as being the minimum resulted from insufficient information of f₂. However, in this case, the fact is that a difference value between f₁ and f₃ is the minimum.

Determination of an initial status (the initial reference temperature) in an example is introduced below: an initial temperature function is T₀=−|Δmax|/ln(pr), in which T₀ represents the initial reference temperature. K (for example: 30 to 200) groups of sets consisting of the two sets of S and T are randomly generated by the matrix M, then all ζ values of every group of S and T are calculated respectively. The maximal difference value among K of values is |Δmax|, i.e., |Δmax|=ζmax−ζmin; pᵣ is an initial acceptance probability (for example: pᵣ=0.9).

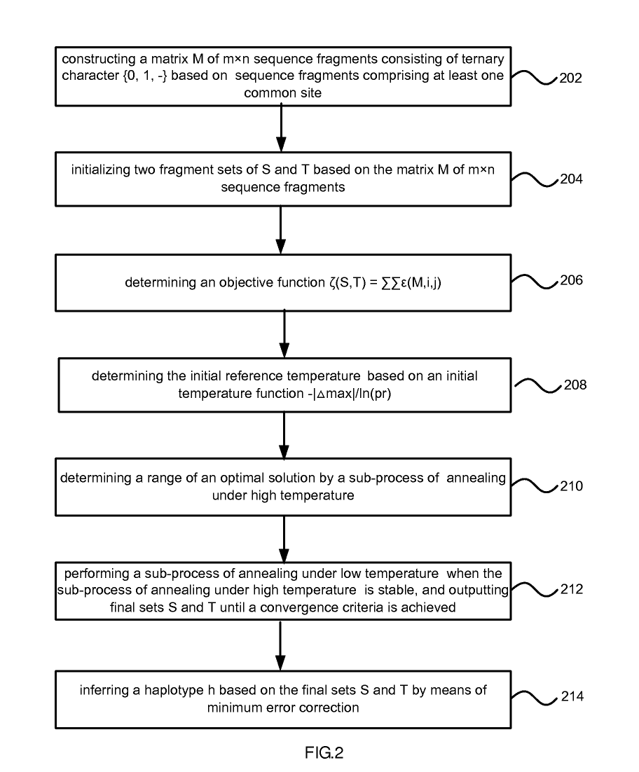

FIG. 2 is a flow chart showing a method of reconstructing a haplotype of a diploid according to another embodiment of the present disclosure.

As shown in FIG. 2, step 202 comprises: constructing a matrix M of m×n sequence fragments consisting of ternary character {0, 1, -} based on sequence fragments comprising at least one common site, wherein in the matrix M of m×n sequence fragments.

Step 204 comprises: initializing two fragment sets of S and T based on the matrix M of m×n sequence fragments.

Step 206 comprises: determining an objective function ζ(S,T)=ΣΣε(M,i,j). For example, a step of determining a scoring matrix:

$$ɛ ( {a}_{1} , {a}_{2} ) = \{ \begin{matrix}1 & ( {a}_{1} \neq - ⋀ {a}_{2} \neq - ⋀ {a}_{1} \neq {a}_{2} ) \\ - 1 & ( {a}_{1} \neq - ⋀ {a}_{2} \neq - ⋀ {a}_{1} = {a}_{2} ) \\ 0 & ( others )\end{matrix} ,$$

in which a₁/a₂ respectively represents a base type of the i-th/j-th sequence fragment at a coordinate of the same site. The scored difference value between fragment i and fragment j is respectively recorded as Σ(M,i,j)=Σε(M[i,k],M[j,k]), in which k∈[1,n], i.e., calculating a different value between the total number of fragments having a same base type of fragments i and those of fragments j, and the total number of fragments having different base type of the fragments i and those of the fragments j. The meaning of such scoring matrix lies in that: by determining a difference value between the total number of fragments having a same base type and the total number of fragments having different base types, a scored difference value of fragments can be obtained, in which the larger of the scored difference value, the greater of difference between two fragments.

Step 208 comprises: determining the initial reference temperature T₀ based on an initial temperature function −|Δmax|/ln(pr), i.e., T₀=−|Δmax|/ln(pr).

The annealing process is one important process during of the algorithm, which affects an acceptance probability when states transit. To more accurately obtain a global optimal solution to avoid becoming into a local optimal solution at late stage of annealing, the process of annealing is divided into two sub-processes: annealing under high temperature and annealing under low temperature.

Step 210 comprises: determining a range of the optimal solution by a sub-process of annealing under high temperature. The sub-process of annealing under high temperature directs to rapidly determine the range of the optimal solution (i.e., the maximum value of narrow a range of solutions. For example, a function of the annealing under high temperature is T=T₀exp(−a(j−1)^{1/2}), in which T₀ is the initial temperature, j is times of iterations, a=0.98. A corresponding pattern of a perturbation model is mᵢ′=mᵢ+μ(Bᵢ−Aᵢ), μ is a random number uniformly distributed within a range of [0, 1], [Aᵢ,Bᵢ] is a range of the perturbation, and mᵢ∈[Aᵢ,Bᵢ]. For example, assuming that there are 50 of sequence fragments, then the range of perturbation is [1,50].

Step 212 comprises performing a sub-process of annealing under low temperature when the sub-process of annealing under high temperature is stable, and outputting final sets S and T until a convergence criteria is achieved. When the sub-process of annealing under high temperature is stable (determination whether the sub-process of annealing under high temperature is stable refers to illustration in examples below), the sub-process of annealing under high temperature is convert to a sub-process of annealing under low temperature. For example, a function of the annealing under low temperature is T=T₀exp(−α(j−k0/β)^{1/2}), in which T₀ is the initial temperature, j represents times of annealing, k₀ represents times of the annealing under high temperature, α=0.98, β=1.2. A corresponding pattern of a perturbation model is mᵢ′=mᵢ+μ(Bᵢ−Aᵢ), μ is a random number uniformly distributed within a range of [0, 1], [Aᵢ,Bᵢ] is a range of the perturbation, and mᵢ∈[Aᵢ,Bᵢ]. It can be seen that such function of the annealing under low temperature, at first beginning of converting to the sub-process of the annealing under low temperature, the whole system suffers a certain extend of tempering and heating, which benefit to avoid falling into a local optimal solution which the sub-process of the annealing under high temperature.

Step 214 comprises inferring a haplotype h based on the final sets S and T by means of minimum error correction. For each column j (j∈[1, n]), in which m_{j,0} represents the number of 0 in the column, m_{j,1} represents the number of 1 in the column, hⱼ represents the inferred base type of the column. If m_{j,0}>m_{j,1}, then hⱼ=0; if m_{j,1}>m_{j,0}, then hⱼ=1; and hⱼ=- represents being uncertain in the case of not belonging to the above two cases. After h has been determined, the other haplotype corresponding thereof may be obtained by means of a complementary relationship.

In the above embodiment, the bipartite graph is constructed by a method of setting a dual threshold in the sub-process of annealing under high temperature and low temperature respectively, by which two haplotypes of H=(h1, h2) of a genome in a diploid may be finally reconstructed, which not only guarantee the accuracy of the reconstructed haplotype, but also accelerate convergence by consuming less time.

The process of annealing (comprising both high temperature and low temperature) is divided into two closely-linked sub-steps:

(1) Metropolis sampling stability criteria: if ζ value of the objective function achieves stable at one same annealing temperature t, then the iteration is stopped and converted to anneal. At the same annealing temperature t, one of sequence fragments v is randomly selected from S or T each time using Metropolis sampling stability criteria, if v∈S, then T∪v, if v∈T, then S∪v, by which ζ value is recalculated after such conversion. If the recalculated ζ value becomes larger, then the conversion is accepted, if the recalculated ζ value becomes smaller or unchanged, then a value of an acceptance probability function exp(−Δζ/T) by then is calculated, which is compared with the random number between 0 to 1 to determine whether the conversion should be accepted. Specific Metropolis sampling stability criteria is shown below: assuming that a value of the objective function obtained after the i−1-th iteration is ζ_{old}, a value of the objective function obtained after the i-th conversion is ζ_{new}, a difference value between ζ_{old} and ζ_{new} is Δζ=ζ_{new}−ζ_{old}, in which ζ_{new}≧ζ_{old}. Generating a random number p between [0, 1], if p<exp(−Δζ/T), then the conversion is accepted, while making ζ_{old}=ζ_{new}; if p>exp(−Δζ/T), then the conversion is abandoned, while going back to the previous state. The above step of sampling is repeated (m is the number of sequence fragments), if the objective function does not change for continuous W times (for example, if m<10, then W=15×m; if m≧10, then W=150), which can be regarded as achieving Metropolis sampling stability criteria, by then the Metropolis sampling is stopped while going back to the current optimal solution and corresponding state. Subsequently, the sub-process of annealing under low temperature is performed by means of the function of the annealing under low temperature, then the obtained values are subjected to Metropolis sampling for determination.

(2) algorithm convergence criteria: after continuously annealing for N times (for example, if m<10, then N=5×m times; if m≧10, then N=50 times, in which m is the number of the sequence fragments in the matrix), the whole algorithm has reached a final convergence when all ζ values of the objective function remains constant. By then two sets of S and T are output as the final optimal solution, while terminating the algorithm.

Usually, the SNP site in chromosome fragments may be subjected to filtering prior to constructing the matrix with the sequence fragments, to remove a homozygous SNP site and an SNP site, wherein the SNP site comprising two or more allelic bases.

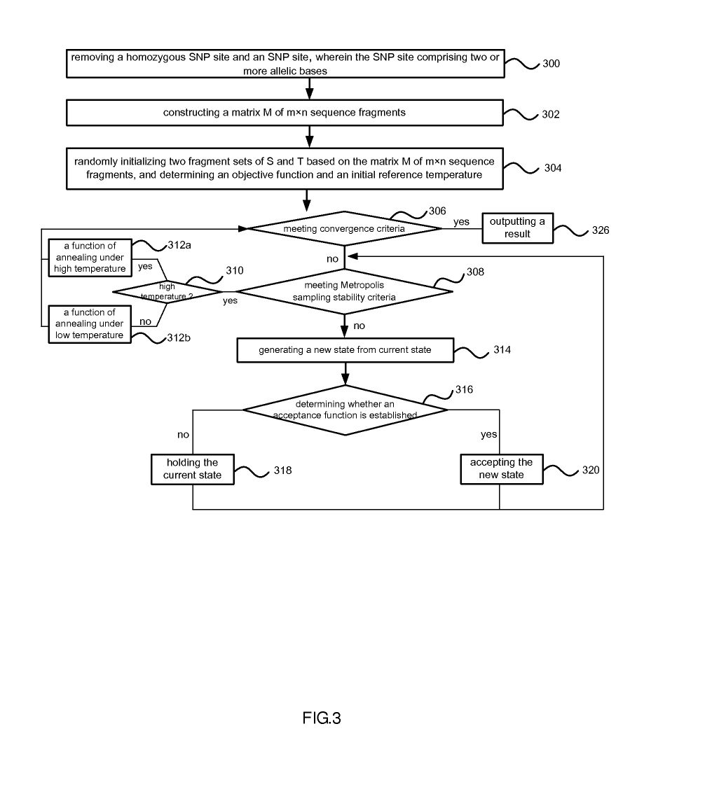

FIG. 3 is a flow chart showing a method of constructing a haplotype of a diploid according to a still another embodiment of the present disclosure.

As shown in FIG. 3, step 300 comprises subjecting the SNP site in chromosome fragments to filtering, to remove a homozygous SNP site and an SNP site, wherein the SNP site comprising two or more allelic bases.

Step 302 comprises constructing a matrix M of m×n sequence fragments.

Step 304 comprises randomly initializing two fragment sets of S and T based on the matrix M of m×n sequence fragments, and determining an objective function and an initial reference temperature.

Step 306 comprises determining whether the two fragment sets of S and T meet convergence criteria. If the two fragment sets of S and T meet the convergence criteria, then a result is output (step 326); if the two fragment sets of S and T do not meet the convergence criteria, step 308 continues.

Step 308 comprises determining whether Metropolis sampling stability criteria is satisfied. If Metropolis sampling stability criteria is satisfied, then step 310 continues; if Metropolis sampling stability criteria is not satisfied, then step 314 continues.

Step 310 comprises determining whether current state belongs to a sub-process of annealing under high temperature. If current state belongs to a sub-process of annealing under high temperature, then step 312a continues, in which a function of annealing under high temperature is used; if the current state does not belong to a sub-process of annealing under high temperature, then step 312b continues, in which a function of annealing under low temperature is used.

Step 314 comprises generating a new state from current state.

Step 316 comprises determining whether an acceptance function is established. If the acceptance function is established, then the new state is accepted (step 320); if the acceptance function is not established, the current state is hold (step 318) while going back to step 308.

It should not that serial numbers of steps in FIG. 3 does not represent a sequential order for executing corresponding step. In step 308, after meeting “Metropolis sampling stability criteria”, a process under an annealing temperature is performed, however, which one of the sub-process of annealing under high temperature and the sub-process of annealing under low temperature should be selected when performing the process under the annealing temperature, of which two different functions of annealing temperature are respectively used in such two sub-processes. Step 310 determines which one of the sub-process of annealing under high temperature (step 312a) and the sub-process of annealing under low temperature (step 312b) should be selected at this very moment. The function of annealing under high temperature is used if Step 310 determines the sub-process of annealing under high temperature; the function of annealing under low temperature is used if Step 310 determines the sub-process of annealing under low temperature. However, one particular point should be note that the algorithm does not crossly present in the sub-processes of annealing under high temperature and low temperature during reconstructing the haplotype, which must be two strictly-separated sub-processes, i.e., after the sub-process of annealing under high temperature is performed, the sub-process of annealing under low temperature is subsequently performed, phenomenon of performing the sub-process of annealing under high temperature from the sub-process of annealing under low temperature does not present, in addition, a step of tempering and heating also belongs to the sub-process of annealing under low temperature.

FIG. 3 is a flow chart showing a method of reconstructing a haplotype with an objective function ζ based on simulated annealing.

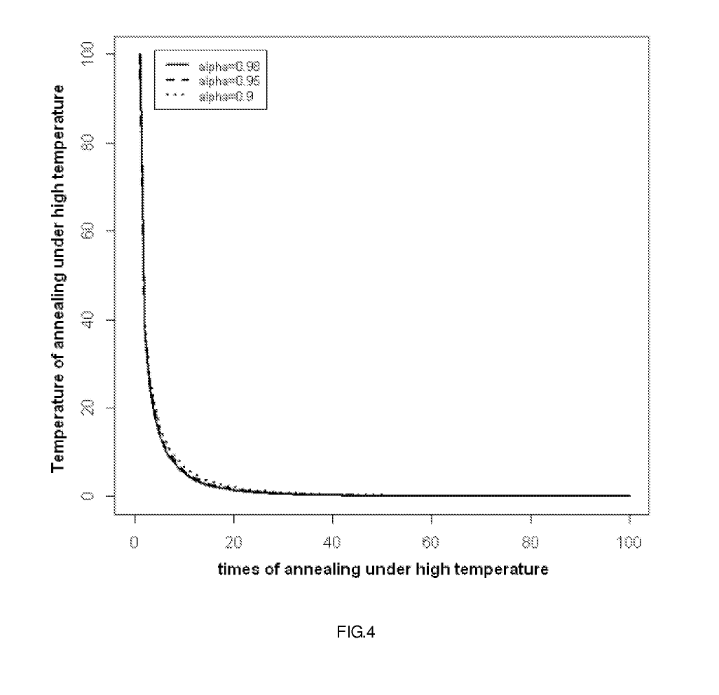

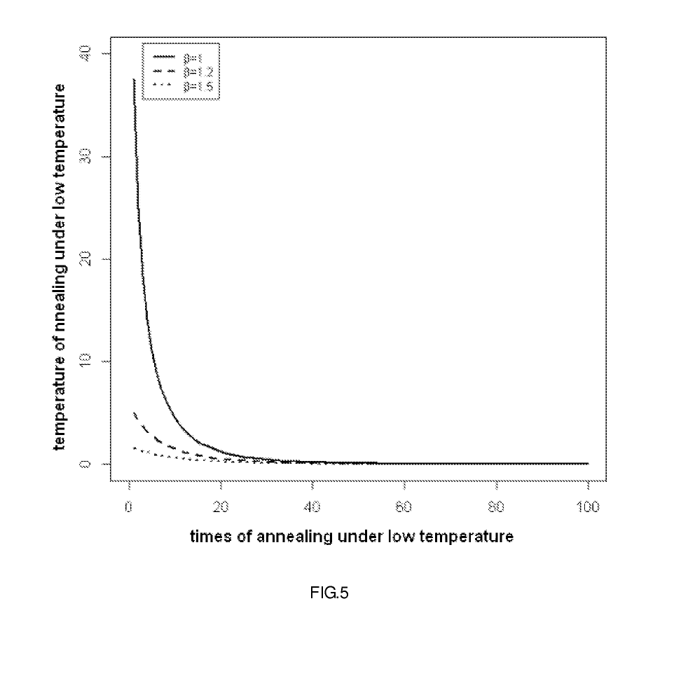

Value ranges of parameters α and β in examples: chilling speed is affected by different value ranges of parameters α and β in the annealing function. Inventors of the present disclosure simulates a declining process of annealing temperature T, at an initial temperature of T₀=100, times of chilling j∈[1,100], when values of parameter α are 0.98, 0.95 and 0.9 respectively. It can be seen from FIG. 4 that there is no obvious difference of declining speed of the annealing temperature when the value of parameter α diminished. But for accelerate the sub-process of annealing under high temperature to reduce times of iteration, the value of parameter α=0.98 is selected in the present disclosure. The inventors of the present disclosure also simulates a declining process of annealing temperature T, at an initial temperature of T₀=100, times of chilling j∈[51,150], times of annealing under high temperature is k₀=50, when values of parameter β are 1, 1.2 and 1.5 respectively. It can be seen from FIG. 5 that difference of the declining speed of annealing temperature is significant when the value of parameter β diminished. The step of tempering and heating is benefit to avoid falling into a local optimal solution, and the value of parameter β=1.2 is selected in the present disclosure for avoiding an excessive speed of annealing under low temperature.

### Example 1

### Indicator of Result Evaluation SE

The inventors of the present disclosure used switch error (SE, also known as reconstruction error) for evaluating accuracy of haplotype reconstruction result in the present disclosure. Formula for calculating SE was:

SE=min{d(h_{reconstruct}, hᵣₑₐₗ₁), d(h_{reconstruct}, hᵣₑₐₗ₂)}/n, in which h_{reconstruct} represented one haplotype in the reconstruction result, d(h_{reconstruct}, hᵣₑₐₗ₁) and d(h_{reconstruct}, hᵣₑₐₗ₂) represented the SNP numbers of one reconstructed haplotype unmatched respectively with two generated standard haplotype, in which n represented the SNP number in the reconstructed result, and SE represented a percentage of the minimum SNP number unmatched between the reconstructed result and simulated authentic result. A smaller value of SE indicated the reconstructed haplotype based on simulated date was more similar with the authentic result, and the accuracy is higher.

A relationship between SE and overlap level of sequence fragments was firstly evaluated: the overlap level of chromosome fragments was defined as:

Pₒᵥₑᵣₗₐₚ_{_{—}}ₗₑᵥₑₗ=Σ₁ⁿNₒᵥₑᵣₗₐₚ/(m×n),

in which m represented the number of sequence fragments (i.e., the number of the above matrix M of sequence fragments), n represented the number of SNP sites (i.e., the number of columns of the matrix M of sequence fragments), ΣNₒᵥₑᵣₗₐₚ represented the sum of depths of all SNP sites presenting in two or more sequence fragments. A specific example was shown below as Table 1:

TABLE 1

| No. of | | | | | | | | | | | | | |
|---|---|---|---|---|---|---|---|---|---|---|---|---|---|
| fragment | SNP site sequence in fragments | | | | | | | | | | | | |
| fragment 1 | 1 | 0 | 1 | 1 | 1 | 1 | 1 | — | — | — | — | — | — |
| fragment 2 | — | — | — | 1 | 0 | 1 | 0 | 1 | 1 | 1 | 1 | 1 | 1 |
| fragment 3 | — | — | — | 1 | 0 | — | — | — | — | — | — | — | — |

ΣNₒᵥₑᵣₗₐₚ=4+4+2=10

m=3

n=13

Pₒᵥₑᵣₗₐₚ_{_{—}}ₗₑᵥₑₗ=10/(3×13)=0.25641

Pₒᵥₑᵣₗₐₚ_{_{—}}ₗₑᵥₑₗ reflected those sequence fragments having an overlapping relationship in the whole matrix M of sequence fragments, and a proportion occupied by SNP site, as well as adequacy level of available information. Such proportion not only could illustrate frequency that every SNP sites were repeat-used averagely, but also could illustrate compactness level among the sequence fragments. The more overlapping SNP site among sequence fragments (i.e., the frequency that every SNP sites were repeat-used averagely is larger) or more compact among sequence fragments, then the larger Pₒᵥₑᵣₗₐₚ_{_{—}}ₗₑᵥₑₗ, and larger adequacy of the available information.

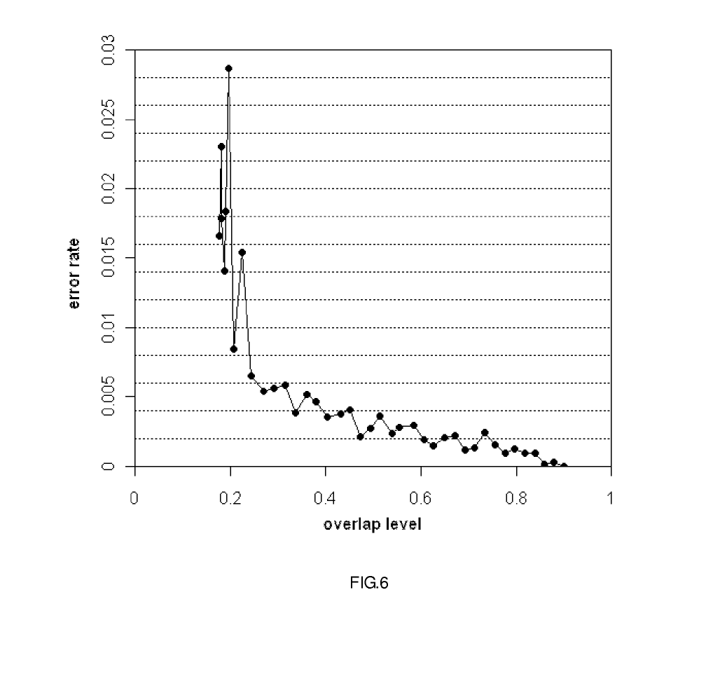

Inventors of the present disclosure randomly generated 39 sets of simulated data for evaluate the overlap level of the chromosome fragments and the relationship of SE. Every set of data consisted of randomly generated 50-pair of standard haplotypes and chromosome fragments generated based on the haplotype. Between each set of data, the number of SNP sites included in the standard haplotypes was same, being 200; the number of correspondingly generated chromosome fragments was also same, being 20; however, the number of SNP site included in the chromosome fragments was 5 added to every set of data from 10. To make the simulated data more close to the authentic data, deletion and inversion of SNP site were also considered in chromosome fragments. During generating simulated data, a probability of deletion of each heterozygous SNP site in chromosome fragment was 0.9, which was far beyond the authentic situation. If a good result could also be obtained under this condition, then it indicated that the method of the present disclosure was of significance in practical applications. Meanwhile, a probability of transversion was set as 0.05. Finally, by calculation a range of Pₒᵥₑᵣₗₐₚ_{_{—}}ₗₑᵥₑₗ (i.e., overlap level), deriving from 39 sets of simulated data, was generated being as 0.18 to 0.90; and a range of corresponding SE (i.e., reconstructed error) was generated being as 0 to 0.03. In FIG. 6, X-coordinate represented the overlap level (namely Pₒᵥₑᵣₗₐₚ_{_{—}}ₗₑᵥₑₗ below), Y-coordinate represented the reconstructed error (namely SE below). It can be seen from FIG. 6, the value of SE rapidly decreased with increased value of Pₒᵥₑᵣₗₐₚ_{_{—}}ₗₑᵥₑₗ. It should note that the maximum SE did not reach to 0.03 in the case of these data, being equivalent to an accuracy of at least 97%, which was already quite high; while when the value of Pₒᵥₑᵣₗₐₚ_{_{—}}ₗₑᵥₑₗ reached to 20% or more, the value of SE was already below 0.01. The above-mentioned indicated that the method according to embodiments of the present disclosure could obtain extremely high accuracy when reconstructing haplotype.

### Example 2

### A Relationship of Transversion Rate Between SE and SNP

To evaluate the relationship of transversion rate between SE and SNP, the inventors of the present disclosure generated simulated data of the transversion rate of SNP site at different coverage depths from smaller value to larger value.

The coverage depth of SNP site included 10×, 20×, 30×, 40× and 50×. Each of the coverage depth further included 7 sets of simulated data having a respective transversion rate of 0.01, 0.05, 0.1, 0.2, 0.3, 0.4 and 0.5. Each set of simulated data consisted of randomly generated 50-pair standard haplotype and chromosome fragments generated based on the haplotype. Formula for calculating SNP coverage depth was:

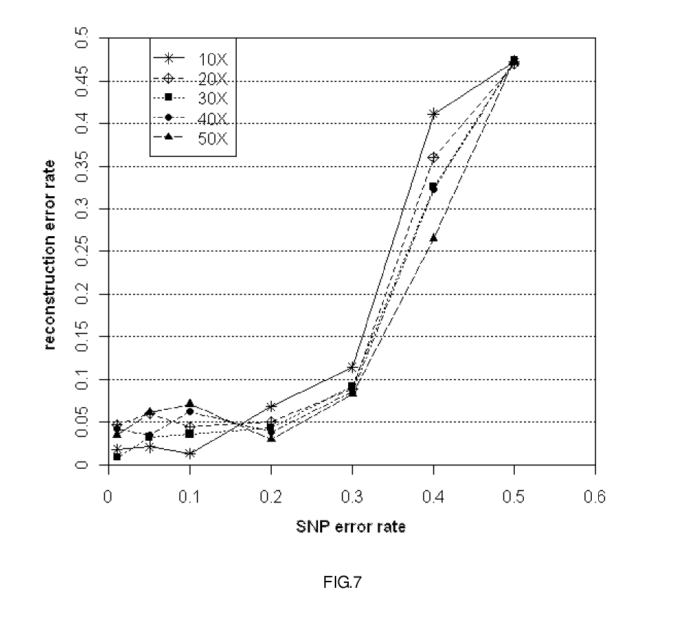

C=m×L×(L−d)/N,

in which m represented the fragment number of chromosome, L represented an average length of the chromosome fragment, d represented a deletion rate of SNP site, N represented the number of the standard haplotype comprising SNP site. For simulated data having different depths N=200, I=20, m was respectively 110, 220, 330, 440 and 550. By calculating values of SE and SNP error at different depths, shown as FIG. 7, it could be obviously seen from FIG. 7 that haplotype reconstruction error gradually increased with the increased SNP error resulted from sequencing, particularly after the SNP error achieved to 0.3 or more, the haplotype reconstruction error directly increased up to 0.25 or more, which was not acceptable. However, under normal circumstance, sequencing did not lead to such large error rate; under special circumstance, individual maximum value reached to 0.05, which meant that the method according to the embodiments of the present disclosure also had practical significance.

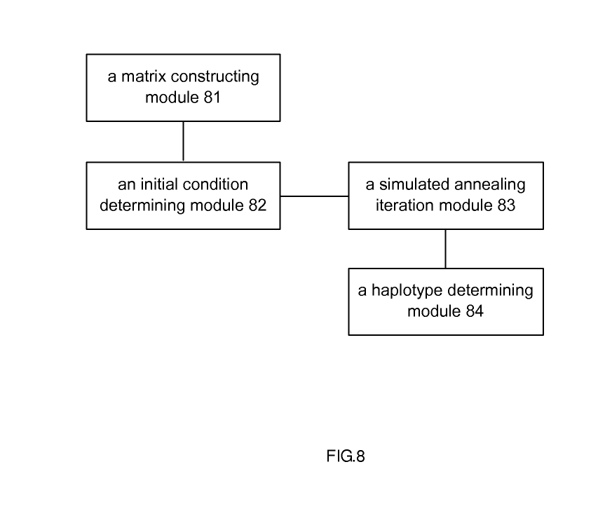

FIG. 8 is a structural chart showing a system for reconstructing a haplotype of a diploid according to an embodiment of the present disclosure. As shown in FIG. 8, a system for reconstructing a haplotype of a diploid according to the embodiment of the present disclosure may comprise:

a matrix constructing module 81, configured to construct a matrix M of m×n sequence fragments consisting of ternary character {A, B, C} based on sequence fragments comprising at least one common site, wherein in the matrix M of m×n sequence fragments, two allelic bases of an SNP site in chromosome fragments are labeled with A and B respectively, m is the number of rows of the matrix M, and m represents the number of the chromosome fragments, n is the number of columns of the matrix M, and n represents the number of heterozygous SNP sites;

an initial condition determining module 82, configured to initialize two fragment sets S and T based on the matrix M of m×n sequence fragments, wherein S∪T=M and S∩T=φ, φ represents a null set; and to determine a objective function ζ(S,T)=ΣΣε(M,i,j) and an initial reference temperature T₀, wherein i∈S, j∈T, ε(M,i,j) represents a difference value between the total number of fragments having a same base type of fragments i and those of fragments j, and the total number of fragments having different base type of the fragments i and those of the fragments j;

a simulated annealing iteration module 83, configured to perform a process of simulated annealing based on the objective function and the initial reference temperature T₀, and to output final sets S and T until a convergence criteria is achieved;

a haplotype determining module 84, configured to infer a haplotype h based on the final sets S and T by means of minimum error correction.

In an embodiment, the haplotype determining module 84 may further comprise:

for each column j(j∈[1, n]), in which m_{j,0} represents the number of 0 in the column, m_{j,1} represents the number of 1 in the column, hⱼ represents the inferred base type of the column. If m_{j,0}>m_{j,1}, then hⱼ=0; if m_{j,1}>m_{j,0}, then hⱼ=1; and hⱼ=- represents being uncertain in the case of not belonging to the above two cases.

In an embodiment, the initial reference temperature T₀ is determined by following steps:

T₀=−|Δmax|/ln(pr), wherein

|Δmax|=ζₘₐₓ−ζₘᵢₙ,

pᵣ is an initial acceptance probability,

ζₘₐₓ/ζₘᵢₙ represents the maximum/minimum value in all ζ values of every group of S and T, which is calculated based on K groups of sets consisting of the two sets of S and T which are randomly generated by the matrix M,

K is a natural number being 2 or more.

In an embodiment, the simulated annealing iteration module 83 determines whether or not stop iterating and start annealing by Metropolis sampling stability criteria; a convergence criteria for the process of simulated annealing used by the simulated annealing iteration module 83 is: whether whole algorithm has reached a final convergence is determined when ζ value of the objective function remains constant after continuously annealing for predetermined times.

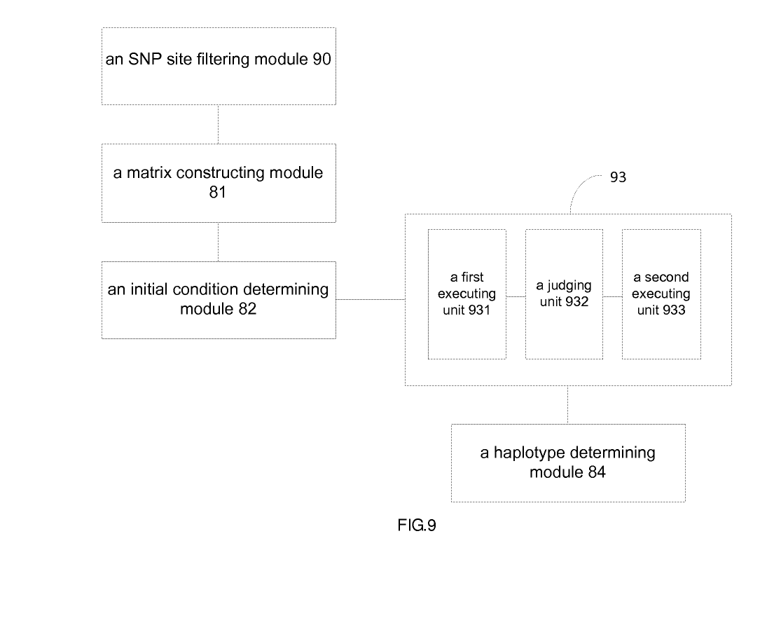

FIG. 9 is a structural chart showing a system for reconstructing a haplotype of a diploid according to another embodiment of the present disclosure. As shown in FIG. 9, the system for constructing the haplotype of the diploid according to the embodiment of the present disclosure may further comprise:

an SNP site filtering module 90, configured to subject the SNP site in chromosome fragments to filtering, to remove a homozygous SNP site and an SNP site, wherein the SNP site comprising two or more allelic bases.

In an embodiment, the simulated annealing iteration module 93 comprises:

a first executing unit 931, configured to perform a sub-process of annealing under high temperature and determine a range of an optimal solution thereby, wherein a function of the annealing under high temperature is T=T₀exp(−α(j−1)^{1/2});

a judging unit 932, configured to determine whether or not the sub-process of annealing under high temperature is stable, and to convert to a sub-process of annealing under low temperature when the sub-process of annealing under high temperature is stable;

a second executing unit 933, configured to perform the sub-process of annealing under low temperature, wherein a function of the annealing under low temperature is T=T₀exp(−α(j−k0/β)^{1/2});

wherein T₀ is the initial reference temperature, j represents times of annealing, k₀ represents times of the annealing under high temperature, α=0.98, β=1.2.

Functions of every module or unit in FIG. 8 and FIG. 9 may refer to corresponding part in the description herein according to the embodiments of the present disclosure. For brevity, elaborate description was omitted.

It would be appreciated by those skilled in the art that, every module or unit in FIG. 8 and FIG. 9 may be realized by separate computer devices, or by an integrated independent device. Frames are used in FIG. 8 and FIG. 9 for illustrating their functions. Such functional blocks may be realized using hardware, software, firmware, middleware, microcode, hardware description voice or any combinations thereof. For example, one or two functional block(s) may be realized by means of code running in microprocessor, digital signal processor (DSP) or any other appropriate computer device. The code may represent process, function, subprogram, program, routine program, subroutine program, module or any combinations of order, data structure or program statement. The code may be located in computer readable medium. The computer readable medium may comprise one or more storage device, for example, comprise Random Access Memory (RAM), flash memory, Read Only Memory (ROM), Erasable Programmable Read Only Memory (EPROM), Electrical Erasable Programmable Read Only Memory (EEPROM), register, hard disk, mobile hard disk drive, CD-ROM or any other forms of storage medium in the art. The computer readable medium may further comprise carrier wave of encoded data signal.

It would be appreciated by those skilled in the art that configuration of such hardware, firmware and software has replaceability under these circumstances, and how to best realize functions of every specific application.

In the present disclosure, a new method of reconstructing a haplotype of a diploid and a system there of are provided based on mature sequence technology and haplotype reconstruction method already existing in the art, which may determine a global optimal solution of an objective function within a relative short time, and further complete haplotype reconstruction.

Descriptions of the present disclosure are given for illustrations and explanations, which are not exhaustive, cannot be construed to limit the present disclosure. Many modifications and changes can be made in the embodiments without departing from spirit, which are obvious to those skilled in the art. Selection and description of the embodiments directs to better explain principle and practical application of the present disclosure, which are designed to make those skilled in the art better understood the present disclosure.

What is claimed is:

1. A method of reconstructing a haplotype of a diploid, comprising following steps:
constructing a matrix M of m×n sequence fragments consisting of ternary character {A, B, C} based on sequence fragments comprising at least one common site, wherein in the matrix M of m×n sequence fragments, two allelic bases of an SNP site in chromosome fragments are labeled with A and B respectively, m is the number of rows of the matrix M, and m represents the number of the chromosome fragments, n is the number of columns of the matrix M, and n represents the number of heterozygous SNP sites;
initializing two fragment sets of S and T based on the matrix M of m×n sequence fragments, wherein S∪T=M and S∩T=φ, φ represents a null set;
determining an objective function ζ(S,T)=ΣΣε(M,i,j) and an initial reference temperature T₀, wherein i∈S, j∈T, ε(M,i,j) represents a difference value between the total number of fragments having a same base type of fragments i and those of fragments j and the total number of fragments having different base type of the fragments i and those of the fragments j;
performing a process of simulated annealing based on the objective function and the initial reference temperature T₀, and outputting final sets S and T until a convergence criteria is achieved;
inferring a haplotype h based on the final sets S and T by means of minimum error correction.

2. The method of claim 1, wherein the initial reference temperature T₀ is T₀=−|Δmax|/ln(pr),
wherein

|Δmax|=ζₘₐₓ−ζₘᵢₙ,
pᵣ is an initial acceptance probability,
ζₘₐₓ/ζₘᵢₙ represents the maximum/minimum value in all ζ values of every group of S and T, which is calculated based on K groups of sets consisting of the two sets of S and T which are randomly generated by the matrix M,
K is a natural number being 2 or more.

3. The method of claim 1, wherein the step of performing a process of simulated annealing based on the objective function and the initial reference temperature T₀ comprises:
determining a range of an optimal solution by a sub-process of annealing under high temperature, wherein a function of the annealing under high temperature is T=T₀exp(−α(j−1)^{1/2});
performing a sub-process of annealing under low temperature when the sub-process of annealing under high temperature is stable, wherein a function of the annealing under low temperature is T=T₀exp(−α(j−k0/β)^{1/2});
wherein T₀ is the initial reference temperature, j represents times of annealing, k₀ represents times of the annealing under high temperature, α=0.98, β=1.2.

4. The method of claim 3, further comprising a step of:
determining whether or not stop iterating and start annealing by Metropolis sampling stability criteria.

5. The method of claim 1, wherein the convergence criteria for the process of simulated annealing is that:
whether whole algorithm has reached a final convergence is determined when ζ value of the objective function remains constant after continuously annealing for predetermined times.

6. The method of claim 1, wherein the ternary character {A, B, C} is {0, 1, -}.

7. The method of claim 1, wherein the step of inferring the haplotype h based on the final sets S and T by means of minimum error correction comprises:
for each column j, j∈[1, n], wherein m_{j,0} represents the number of 0 in the column, m_{j,1} represents the number of 1 in the column, hⱼ represents the inferred base type of the column;
hⱼ=0, if m_{j,0}>m_{j,1};
hⱼ=1, if m_{j,1}>m_{j,0};
hⱼ=-, if not belonging to the above two cases.

8. The method of claim 1, further comprising a step of:
subjecting the SNP site in chromosome fragments to filtering, to remove a homozygous SNP site and an SNP site, wherein the SNP site comprising two or more allelic bases.

9. A system for reconstructing a haplotype of a diploid comprising:
a matrix constructing module, configured to construct a matrix M of m×n sequence fragments consisting of ternary character {A, B, C} based on sequence fragments comprising at least one common site, wherein in the matrix M of m×n sequence fragments, two allelic bases of an SNP site in chromosome fragments are labeled with A and B respectively, m is the number of rows of the matrix M, and m represents the number of the chromosome fragments, n is the number of columns of the matrix M, and n represents the number of heterozygous SNP sites;
an initial condition determining module, configured to initialize two fragment sets S and T based on the matrix M of m×n sequence fragments, wherein S∪T=M and S∩T=φ, φ represents a null set; and to determine a objective function ζ(S,T)=ΣΣε(M,i,j) and an initial reference temperature T₀, wherein i∈S, j∈T, ε(M,i,j) represents a difference value between the total number of fragments having a same base type of fragments i and those of fragments j and the total number of fragments having different base type of the fragments i and those of fragments j;
a simulated annealing iteration module, configured to perform a process of simulated annealing based on the objective function and the initial reference temperature T₀, and to output final sets S and T until a convergence criteria is achieved; and
a haplotype determining module, configured to infer a haplotype h based on the final sets S and T by means of minimum error correction.

10. The system of claim 9, wherein the initial reference temperature T₀ is T₀=−|Δmax|/ln(pr), wherein

|Δmax|=ζₘₐₓ−ζₘᵢₙ,
pᵣ is an initial acceptance probability,
ζₘₐₓ/ζₘᵢₙ represents the maximum/minimum value in all ζ values of every group of S and T, which is calculated based on K groups of sets consisting of the two sets of S and T which are randomly generated by the matrix M,
K is a natural number being 2 or more.

11. The system of claim 9, wherein the simulated annealing iteration module comprises:
a first executing unit, configured to perform a sub-process of annealing under high temperature and determine a range of an optimal solution thereby, wherein a function of the annealing under high temperature is T=T₀exp(−α(j−1)^{1/2});
a judging unit, configured to determine whether or not the sub-process of annealing under high temperature is stable, and to convert to a sub-process of annealing under low temperature when the sub-process of annealing under high temperature is stable;
a second executing unit, configured to perform the sub-process of annealing under low temperature, wherein a function of the annealing under low temperature is T=T₀exp(−α(j−k0/β)^{1/2});
wherein T₀ is the initial reference temperature, j represents times of annealing, k₀ represents times of the annealing under high temperature, α=0.98, β=1.2.

12. The system of claim 9, wherein the simulated annealing iteration module determines whether or not stop iterating and start annealing by Metropolis sampling stability criteria.

13. The system of claim 9, wherein the convergence criteria for the process of simulated annealing used by the simulated annealing iteration module is that:
whether whole algorithm has reached a final convergence is determined when ζ value of the objective function remains constant after continuously annealing for predetermined times.

14. The system of claim 9, wherein in the haplotype determining module,
for each column j, j∈[1, n], m_{j,0} represents the number of 0 in the column, m_{j,1} represents the number of 1 in the column, hⱼ represents the inferred base type of the column;
hⱼ=0, if m_{j,0}>m_{j,1};
hⱼ=1, if m_{j,1}>m_{j,0};
hⱼ=-, if not belonging to the above two cases.

15. The system of claim 9, further comprising:
an SNP site filtering module, configured to subject the SNP site in chromosome fragments to filtering, to remove a homozygous SNP site and an SNP site, wherein the SNP site comprising two or more allelic bases.
